(19) United States
(12) Patent Application Publication
(10) Pub. No.: US 2026/0242182 A1
(43) Pub. Date: Aug. 20, 2026

(54) Lift Drawn by Motor Driver

(71) Applicant: Shanghai Mitsubishi Elevator Co., Ltd., Shanghai (CN)

(72) Inventors: Wei Li, Shanghai (CN); Xingqi Wang, Shanghai (CN); Kai Fang, Shanghai (CN); Wei Wu, Shanghai (CN); Jie Li, Shanghai (CN)

(73) Assignee: Shanghai Mitsubishi Elevator Co., Ltd., Shanghai (CN)

(21) Appl. No.: 18/852,264

(22) PCT Filed: Jan. 9, 2023
(86) PCT No.: PCT/CN2023/071201

§ 371 Date: Sep. 27, 2024

(30) Foreign Application Priority Data
Apr. 10, 2022 (CN) 202210370587.X

(51) Int. Cl. B66B 11/04; B66B 1/36; B66B 9/00; F16H 57/021

(52) U.S. Cl. CPC B66B 11/043; B66B 1/36; B66B 9/00; F16H 57/021

(57) ABSTRACT

The present application discloses a lift drawn by a motor driver, wherein a miniaturized motor driver is employed to output a relatively large torque, and a traction rope sheave and a traction rope with relatively large diameters are used to increase the traction force of the traction rope, so that the lift is suitable for applications with large loads and high-speed operations. The miniaturized motor driver used not only can reduce an occupied space, facilitating transport, installation, and maintenance, but also can facilitate component manufacture, facilitating raw material saving, machining and assembly time reduction, and component manufacture cost reduction.

### TECHNICAL FIELD

The present application relates to a lift, and in particular to a lift drawn by a motor driver.

### BACKGROUND

A lift usually employs a traction rope with a relatively large diameter for required traction force and ensured sufficient service life in applications where a large load is lifted and operates are carried out at a high speed. According to Section 5.5.2 of Chinese lift standard GB/T 7588.1-2020, the ratio (D/d) of diameter D of a traction rope sheave pitch circle such as traction sheaves, pulleys, reels, etc. to diameter d of a traction rope (a suspended wire rope) should not be less than 40. Therefore, if a traction rope with a relatively large diameter is employed, a traction rope sheave with a relatively large pitch circle diameter is correspondingly adopted, and thus, the motor driver needs to be able to output a relatively larger torque.

The motor driver may output the relatively large torque by using a motor with an increased size. For example, China Patent Publication CN 100335400 C discloses a motor driver in which a rotor of a motor directly drives a rope sheave, and the diameter of a rotor mounting portion is larger than that of the rope sheave to output a relatively large torque, leading to the relatively large size of the motor, and thus the relatively large size of the motor driver.

The large size of the motor driver makes that it is more difficult to make components for the motor driver, and also, a large-sized motor driver occupies relatively much space at a place using a lift, bringing difficulties in handling, installation and maintenance of a lift.

### BRIEF SUMMARY

The technical problem to be solved by the present application is to provide a lift drawn by a motor driver, wherein a miniaturized motor driver is employed to output a relatively large torque, and a traction rope sheave and a traction rope with relatively large diameters are used to increase the traction force of the traction rope, so that the lift is suitable for applications with large loads and high-speed operations. The miniaturized motor driver used not only can reduce an occupied space, facilitating transport, installation, and maintenance, but also can facilitate component manufacture, facilitating raw material saving, machining and assembly time reduction, and component manufacture cost reduction.

To solve the above technical problem, the present application provides a lift drawn by a motor driver, having:
a lifting space 1001;
a car 1002 and a counterweight 1003 lifted and lowered within the lifting space;
a traction rope 1004 suspending the car 1002 and counterweight 1003;
a traction rope sheave 30 combined with the traction rope 1004 has a traction rope sheave pitch circle 310, and the rotational movement of the traction rope sheave 30 lifts and lowers the car 1002 and the counterweight 1003 by means of the traction rope 1004;
a motor driver 1 having a motor 10, and a gear assembly 2; the motor 10 driving rotational movement of the traction rope sheave 30 by the gear assembly 2;
wherein the projection of individual transmission gears of the gear assembly 2 along the axial direction of the traction rope sheave 30 is configured within the area surrounded by the projection of the traction rope sheave pitch circle 310 along the axial direction of the traction rope sheave 30.

According to an embodiment, the axes of the individual transmission gears of the gear assembly 2 are parallel to the axis 320 of the traction rope sheave 30.

According to an embodiment, the axes of the individual transmission gears of the gear assembly 2 are stationary with respect to and parallel to the axis 320 of the traction rope sheave 30.

According to an embodiment, the gear assembly 2 has N transmission gears, the axes of the N transmission gears are not in the same plane and spatially arranged in three dimensions, and N is an integer greater than 2.

According to an embodiment, the individual transmission gears of the gear assembly 2 are between the traction rope sheave 30 and the motor 10 along the axial direction of the traction rope sheave 30.

According to an embodiment, the individual transmission gears of the gear assembly 2 are helical gears.

According to an embodiment, the motor driver 1 further has a gear box 20, the individual transmission gears of the gear assembly 2 are configured within the gear box 20, and the gear box 20 supports the rotation of the individual transmission gears of the gear assembly 2.

According to an embodiment, the gear assembly 2 comprises an input transmission gear 210, an output transmission gear 220, a first intermediate transmission gear 230, and a second intermediate transmission gear 231;
the input transmission gear 210 is provided with an input rotation shaft 21, and the input rotation shaft 21 is provided with a first bearing 212, and a second bearing 213;
the output transmission gear 220 is provided with an output rotation shaft 22, and the output rotation shaft 22 is provided with a third bearing 222, and a fourth bearing 223;
the first intermediate transmission gear 230, the second intermediate transmission gear 231, and the intermediate transmission rotation shaft 23 are coaxially connected and rotate together;
the intermediate transmission rotation shaft 23 is provided with a fifth bearing 233, and a sixth bearing 234; and
the gear box 20 rotationally supports rotation shafts by the bearings of rotation shafts.

According to an embodiment, the motor 10 has: a fixing portion 11, and a rotation portion 12; the rotation portion 12 of the motor and the input transmission gear 210 of the gear assembly 2 are coaxially connected and rotate together, the traction rope sheave 30 and the output transmission gear 220 of the gear assembly 2 are coaxially connected and rotate together, and the rotational speed of the traction rope sheave 30 is less than that of the rotation portion 12 of the motor.

According to an embodiment, the number of teeth of the input transmission gear 210 is less than that of the transmission gear meshed therewith, and the number of teeth of the output transmission gear 220 is greater than that of the transmission gear meshed therewith.

According to an embodiment, the projection of the rotation portion 12 of the motor along the axial direction of the traction rope sheave 30 is configured within the area surrounded by the projection of the traction rope sheave pitch circle 310 along the axial direction of the traction rope sheave 30.

According to an embodiment, the fixing portion 11 of the motor has a coil 112, and the projection of the coil 112 along the axial direction of the traction rope sheave 30 is configured within the area surrounded by the projection of the traction rope sheave pitch circle 310 along the axial direction of the traction rope sheave 30.

According to an embodiment, the motor driver 1 has a braking device 40, and the braking device 40 has a brake fixing portion 41, a brake moving portion 42, and a braking disk 43.

According to an embodiment, the braking disk 43 and the output transmission gear 220 are coaxially connected and rotate together, and the projection of the braking disk 43 along the axial direction of the traction rope sheave 30 is configured within the area surrounded by the projection of the traction rope sheave pitch circle 310 along the axial direction of the traction rope sheave 30.

According to an embodiment, the braking disk 43 and the rotation portion 12 of the motor are coaxially connected and rotate together, and the projection of the braking disk 43 along the axial direction of the traction rope sheave 30 is configured within the area surrounded by the projection of the traction rope sheave pitch circle 310 along the axial direction of the traction rope sheave 30.

To solve the above technical problem, the present application provides another lift drawn by a motor driver, having:
a lifting space 1001;
a car 1002 and a counterweight 1003 lifted and lowered within the lifting space;
a traction rope 1004 suspending the car 1002 and counterweight 1003;
a traction rope sheave 30 combined with the traction rope 1004 has a traction rope sheave pitch circle 310, and the rotational movement of the traction rope sheave 30 lifts and lowers the car 1002 and the counterweight 1003 by means of the traction rope 1004;
a motor driver 1 having a motor 10, and a gear assembly 2; the motor 10 driving rotational movement of the traction rope sheave 30 by the gear assembly 2;
wherein the axes of the individual transmission gears of the gear assembly 2 are parallel to the axis 320 of the traction rope sheave 30, and the projection of the axes of the individual transmission gears along the axial direction of the traction rope sheave 30 is configured within the area surrounded by the projection of the traction rope sheave pitch circle 310 along the axial direction of the traction rope sheave 30.

According to an embodiment, the axes of the individual transmission gears of the gear assembly 2 are stationary with respect to the axis 320 of the traction rope sheave 30.

According to an embodiment, the gear assembly 2 has N transmission gears, the axes of the N transmission gears are not in the same plane and spatially arranged in three dimensions, and N is an integer greater than 2.

According to an embodiment, the individual transmission gears of the gear assembly 2 are between the traction rope sheave 30 and the motor 10 along the axial direction of the traction rope sheave 30.

According to an embodiment, the individual transmission gears of the gear assembly 2 are helical gears.

According to an embodiment, the motor driver 1 further has a gear box 20, the individual transmission gears of the gear assembly 2 are configured within the gear box 20, and the gear box 20 supports the rotation of the individual transmission gears of the gear assembly 2.

According to an embodiment, the gear assembly 2 comprises an input transmission gear 210, an output transmission gear 220, a first intermediate transmission gear 230, and a second intermediate transmission gear 231;
the input transmission gear 210 is provided with an input rotation shaft 21, and the input rotation shaft 21 is provided with a first bearing 212, and a second bearing 213;
the output transmission gear 220 is provided with an output rotation shaft 22, and the output rotation shaft 22 is provided with a third bearing 222, and a fourth bearing 223;
the first intermediate transmission gear 230, the second intermediate transmission gear 231, and the intermediate transmission rotation shaft 23 are coaxially connected and rotate together;
the intermediate transmission rotation shaft 23 is provided with a fifth bearing 233, and a sixth bearing 234; and
the gear box 20 rotationally supports rotation shafts by the bearings of rotation shafts.

According to an embodiment, the motor 10 has: a fixing portion 11, and a rotation portion 12; the rotation portion 12 of the motor and the input transmission gear 210 of the gear assembly 2 are coaxially connected and rotate together, the traction rope sheave 30 and the output transmission gear 220 of the gear assembly 2 are coaxially connected and rotate together, and the rotational speed of the traction rope sheave 30 is less than that of the rotation portion 12 of the motor.

According to an embodiment, the number of teeth of the input transmission gear 210 is less than that of the transmission gear meshed therewith, and the number of teeth of the output transmission gear 220 is greater than that of the transmission gear meshed therewith.

According to an embodiment, the projection of the rotation portion 12 of the motor along the axial direction of the traction rope sheave 30 is configured within the area surrounded by the projection of the traction rope sheave pitch circle 310 along the axial direction of the traction rope sheave 30.

According to an embodiment, the fixing portion 11 of the motor has a coil 112, and the projection of the coil 112 along the axial direction of the traction rope sheave 30 is configured within the area surrounded by the projection of the traction rope sheave pitch circle 310 along the axial direction of the traction rope sheave 30.

According to an embodiment, the motor driver 1 has a braking device 40, and the braking device 40 has a brake fixing portion 41, a brake moving portion 42, and a braking disk 43.

According to an embodiment, the braking disk 43 and the rotation portion 12 of the motor are coaxially connected and rotate together, and the projection of the braking disk 43 along the axial direction of the traction rope sheave 30 is configured within the area surrounded by the projection of the traction rope sheave pitch circle 310 along the axial direction of the traction rope sheave 30.

According to an embodiment, the braking disk 43 and the output transmission gear 220 are coaxially connected and rotate together, and the projection of the braking disk 43 along the axial direction of the traction rope sheave 30 is configured within the area surrounded by the projection of the traction rope sheave pitch circle 310 along the axial direction of the traction rope sheave 30.

For the lift drawn by a motor driver in the present application, a miniaturized motor driver is employed to output a relatively large torque, so that a traction rope sheave and a traction rope with relatively large diameters are used to increase the traction force of the traction rope and ensure enough service life of the traction rope in view of the provision in Chinese lift standard GB/T 7588.1-2020 that the ratio of the diameter of the traction rope sheave pitch circle to the diameter of the traction rope (D/d) should not be less than 40, and thus the lift is suitable for applications with large loads and high-speed operations. The miniaturized motor driver can facilitate component manufacture, facilitating raw material saving, machining and assembly time reduction, and component manufacture cost reduction. The miniaturized motor driver enables reduction in an occupied space for civil engineering, and facilitates transport, installation, maintenance, etc. of the lift in practice.

### BRIEF DESCRIPTION OF THE DRAWINGS

The figures used in the present application are briefly introduced below to illustrate the technical solutions of the present application more clearly. Obviously, the figures in the following description are only some of the embodiments of the present application, and from the figures, other figures can be obtained by those of ordinary skill in the art without the exercise of inventive effort.

FIG. 1 is a three-dimensional schematic view of an embodiment of a lift drawn by a motor driver in the present application;

FIG. 2 is a three-dimensional schematic view of a motor, a gear assembly, and a traction rope sheave of a motor driver of FIG. 1;

FIG. 3 is a side view of the motor, gear assembly, traction rope sheave, and traction rope of the motor driver of FIG. 1;

FIG. 4 is a C-C sectional view of FIG. 2;

FIG. 5 is a three-dimensional schematic view of the profile of the motor driver and traction rope sheave of FIG. 1;

FIG. 6 is a rear view of the motor driver and traction rope sheave of FIG. 1;

FIG. 7 is a side view of the motor driver and traction rope sheave of FIG. 1;

FIG. 8 is an A-A sectional view of FIG. 7;

FIG. 9 is a B-B sectional view of FIG. 7;

FIG. 10 is a three-dimensional schematic view of the motor driver of FIG. 5 without the gear box;

FIG. 11 is a three-dimensional schematic view of a mounting bracket for the motor driver of FIG. 5;

FIG. 12 is a three-dimensional schematic view of the profile of another embodiment of the motor driver and traction rope sheave of the present application;

FIG. 13 is a side view of FIG. 12; and

FIG. 14 is an A-A sectional view of FIG. 13;

Reference numbers are listed as follows:
1 a motor driver; 2 a gear assembly; 10 a motor; 11 a fixing portion of a motor; 12 a rotation portion of a motor; 20 a gear box; 21 an input rotation shaft; 22 an output rotation shaft; 23 an intermediate transmission rotation shaft; 30 a traction rope sheave; 40 a braking device; 41 a brake fixing portion; 41a bore of a brake fixing portion; 42 a brake moving portion; 43 a braking disc; 50 a sensor; 51 a fixing portion of a sensor; 51 a body portion of a fixing portion of a sensor; 51b a mounting portion of a fixing portion of a sensor; 52 a rotation portion of a sensor; 111 a motor housing; 112 a coil; 113 a motor end cap; 113 a bore of a motor end cap; 210 an input transmission gear; 211 an axis of an input rotation shaft; 212 a first bearing; 213 a second bearing; 220 an output transmission gear; 221 an axis of an output rotation shaft; 222 a third bearing; 223 a fourth bearing; 230 a first intermediate transmission gear; 231 a second intermediate transmission gear; 232 an axis of a transmission rotation shaft; 233 a fifth bearing; 234 a sixth bearing; 310 a traction rope sheave pitch circle; 320 an axis of a traction rope sheave; 1000 a lift; 1001 a lifting space; 1002 a car; 1003 a counterweight; 1004 a traction rope; 1005 a first car diversion sheave; 1006 a second car diversion sheave; 1007 a counterweight diversion sheave; 1008 a car-side traction rope termination device; 1009 a counterweight-side traction rope termination device; 1010 a mounting bracket; D a diameter of a traction rope sheave pitch circle; and d a diameter of a traction rope.

### DETAILED DESCRIPTION OF THE DISCLOSURE

The technical solutions of the present application will be described clearly below in conjunction with the figures. Obviously, described embodiments are part of the embodiments of the present application, not all of the embodiments. Based on the embodiments in the present application, all other embodiments obtained by those of ordinary skill in the art without the exercise of inventive effort fall within the scope of protection of the present application.

### Embodiment I

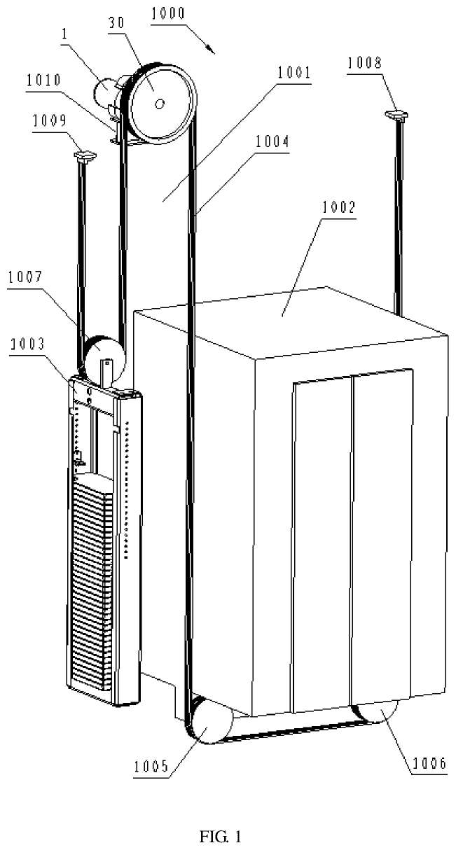

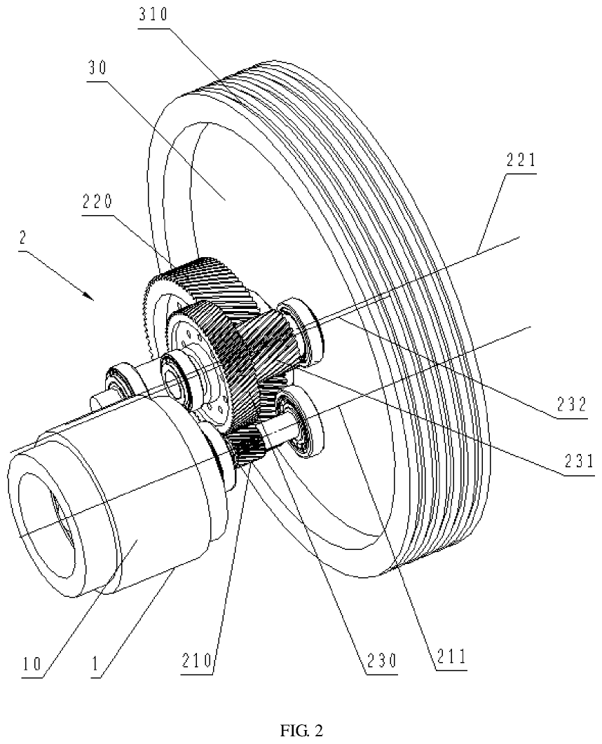

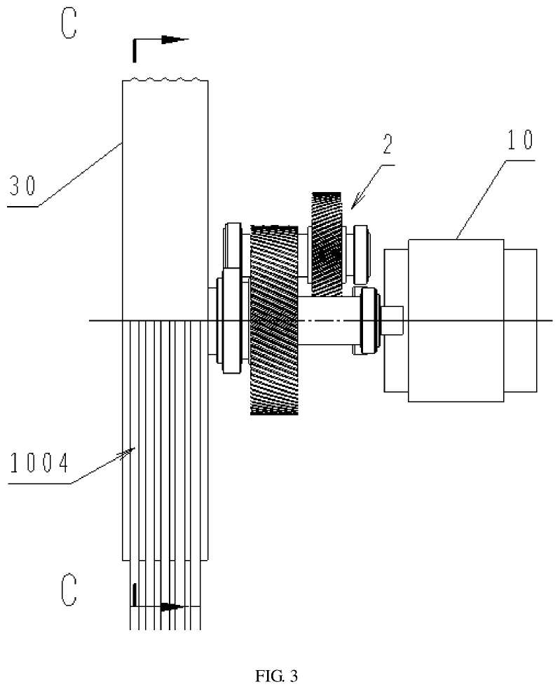

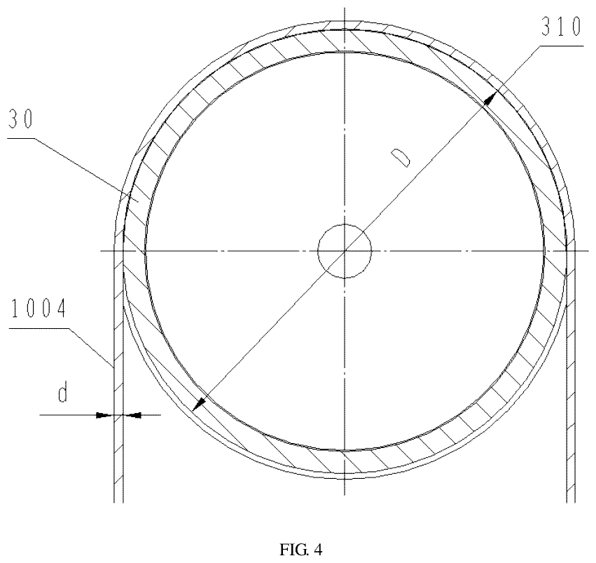

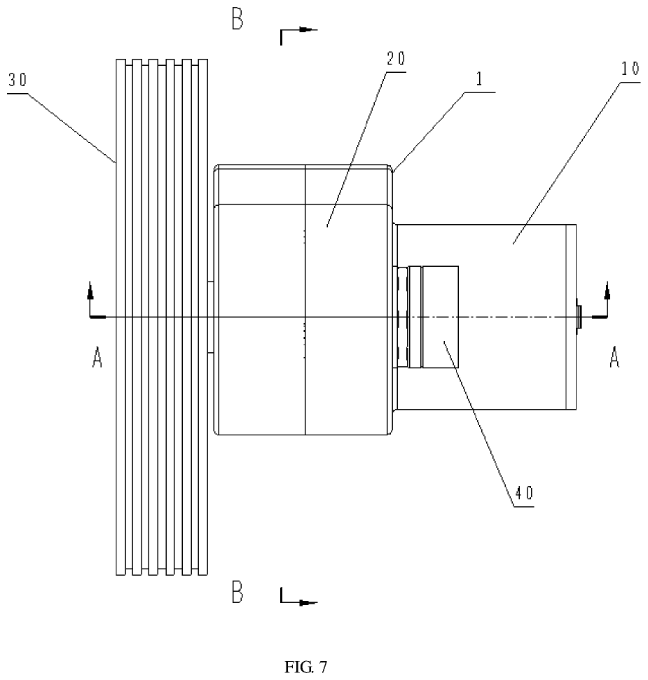

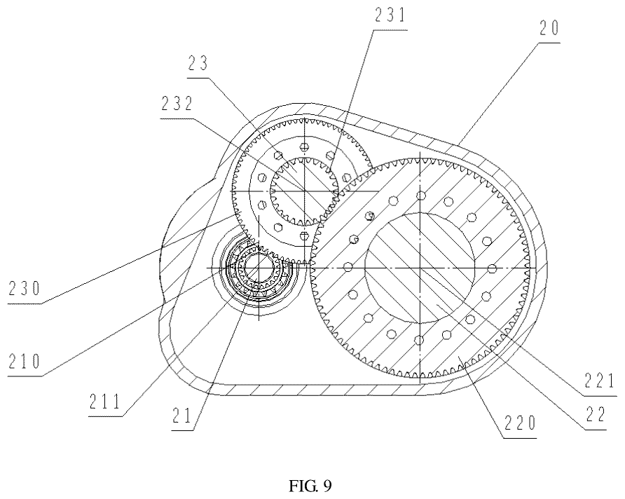

Referring to FIGS. 1-11, a lift drawn by a motor driver, having:
a lifting space 1001;
a car 1002 and a counterweight 1003 lifted and lowered within the lifting space;
a traction rope 1004 suspending the car 1002 and counterweight 1003;
a traction rope sheave 30 combined with the traction rope 1004 has a traction rope sheave pitch circle 310, and the rotational movement of the traction rope sheave 30 lifts and lowers the car 1002 and the counterweight 1003 by means of the traction rope 1004;
referring to FIG. 2, a motor driver 1 has a motor 10, and a gear assembly 2; the motor 10 drives rotational movement of the traction rope sheave 30 by the gear assembly 2;
referring to FIGS. 2-4, the diameter of the traction rope sheave pitch circle 310 is D, and the diameter of the traction rope 1004 is d. Preferably, the ratio of the diameters, D/d, should not be less than 40. The traction rope 1004 converts, in combination with the traction rope sheave 30, the rotational movement of the traction rope sheave 30 into the lifting and lowering movement of the car 1002 and counterweight 1003.

Referring to FIGS. 2-8, the projection of individual transmission gears of the gear assembly 2 along the axial direction of the traction rope sheave 30 is configured within the area surrounded by the projection of the traction rope sheave pitch circle 310 along the axial direction of the traction rope sheave 30.

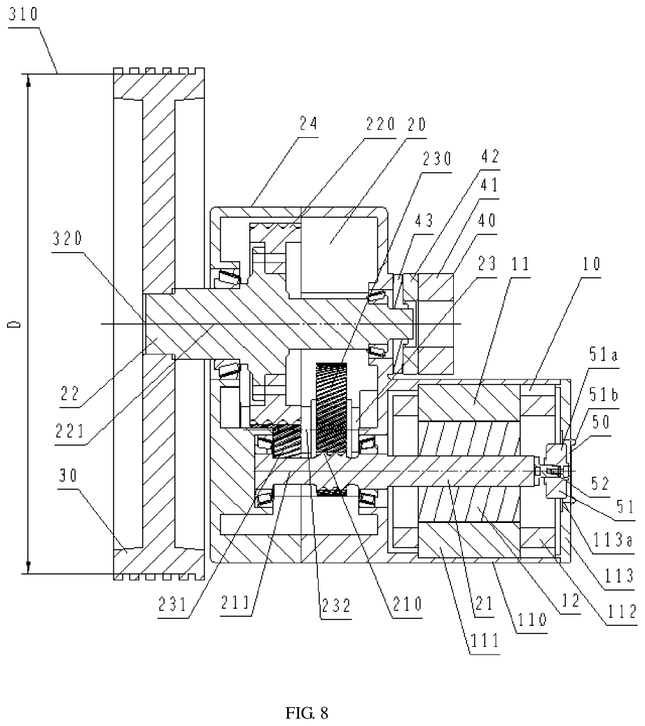

Preferably, referring to FIGS. 2 and 8, the axes of the individual transmission gears of the gear assembly 2 are stationary with respect to and parallel to the axis 320 of the traction rope sheave 30.

Preferably, the gear assembly 2 has N transmission gears, the axes of the N transmission gears are not in the same plane and spatially arranged in three dimensions, and N is an integer greater than 2.

Preferably, the individual transmission gears of the gear assembly 2 comprise an input transmission gear 210, an output transmission gear 220, a first intermediate transmission gear 230, and a second intermediate transmission gear 231.

Preferably, the axis 211 of the input transmission gear 210, the axis 221 of the output transmission gear 220, and the axis 232 of the first intermediate transmission gear 230 and the second intermediate transmission gear 231 of the gear assembly 2 are not in the same plane and spatially arranged in three dimensions.

Referring to FIGS. 2, 6, and 8, the individual transmission gears of the gear assembly 2 are between the traction rope sheave 30 and the motor 10 along the axial direction of the traction rope sheave 30.

Preferably, the individual transmission gears of the gear assembly 2 are helical gears.

Preferably, the motor driver 1 further has a gear box 20, the individual transmission gears of the gear assembly 2 are configured within the gear box 20, and the gear box 20 supports the rotation of the individual transmission gears of the gear assembly 2.

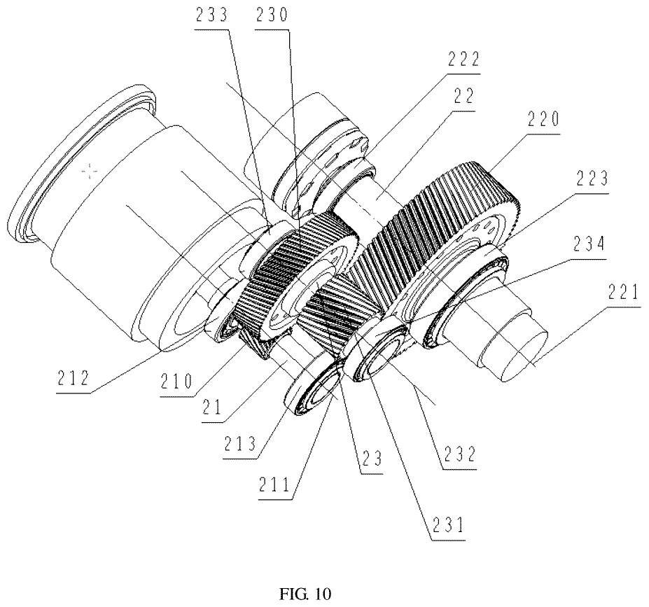

Preferably, referring to FIGS. 8 and 10, the gear assembly 2 comprises an input transmission gear 210, an output transmission gear 220, a first intermediate transmission gear 230, and a second intermediate transmission gear 231;
the input transmission gear 210 is provided with an input rotation shaft 21, and the input rotation shaft 21 is provided with a first bearing 212, and a second bearing 213;
the output transmission gear 220 is provided with an output rotation shaft 22, and the output rotation shaft 22 is provided with a third bearing 222, and a fourth bearing 223;
the first intermediate transmission gear 230, the second intermediate transmission gear 231, and the intermediate transmission rotation shaft 23 are coaxially connected and rotate together;
the intermediate transmission rotation shaft 23 is provided with a fifth bearing 233, and a sixth bearing 234; and
the gear box 20 rotationally supports rotation shafts by the bearings of rotation shafts.

The lift drawn by a motor driver in the present embodiment realizes a compact positional arrangement of gears by reasonably arranging the motor, gear assembly, and traction rope sheave, and reducing a gear arrangement space by adopting a three-dimensional arrangement for the gear assembly. By adopting helical gear transmission, it is beneficial for the motor drive device to output stable and large torque, and is beneficial for the miniaturization of the motor drive device. The miniaturized motor driver not only can reduce an occupied space, facilitating transport, installation, and maintenance, but also can facilitate component manufacture, facilitating raw material saving, machining and assembly time reduction, and component manufacture cost reduction.

### Embodiment II

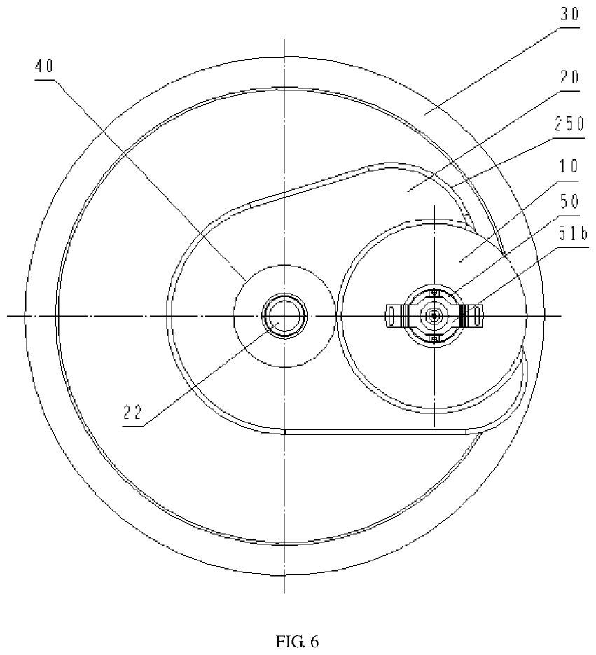

Referring to FIGS. 6, and 8, they show the lift drawn by a motor driver based on embodiment I, the motor 10 has: a fixing portion 11, and a rotation portion 12; the rotation portion 12 of the motor and the input transmission gear 210 of the gear assembly 2 are coaxially connected and rotate together, the traction rope sheave 30 and the output transmission gear 220 of the gear assembly 2 are coaxially connected and rotate together, and the rotational speed of the traction rope sheave 30 is less than that of the rotation portion 12 of the motor.

Preferably, the number of teeth of the input transmission gear 210 is less than that of the transmission gear meshed therewith, and the number of teeth of the output transmission gear 220 is greater than that of the transmission gear meshed therewith.

Preferably, the projection of the rotation portion 12 of the motor along the axial direction of the traction rope sheave 30 is configured within the area surrounded by the projection of the traction rope sheave pitch circle 310 along the axial direction of the traction rope sheave 30

Preferably, the fixing portion 11 of the motor has a coil 112, and the projection of the coil 112 along the axial direction of the traction rope sheave 30 is configured within the area surrounded by the projection of the traction rope sheave pitch circle 310 along the axial direction of the traction rope sheave 30.

Preferably, the fixing portion 11 of the motor has a motor housing 111, and the motor housing 111 is of an integral design with the gear box 20.

When the coil 112 is electrified, the fixing portion 11 of the motor generates an electromagnetic field to drive the rotation portion 12 of the motor, and an output torque is transferred to the traction rope sheave 30 through the input rotation shaft 21, the input transmission gear 210, the first intermediate transmission gear 230, the intermediate transmission rotation shaft 23, the second intermediate transmission gear 231, the output transmission gear 220, and the output rotation shaft 22.

The lift drawn by a motor driver in this embodiment facilitates miniaturization of the motor to further miniaturize the motor driver by reasonably arranging the connection between the motor and the gear assembly to increase a motor torque after the output torque of the motor is transmitted by the gear assembly.

### Embodiment III

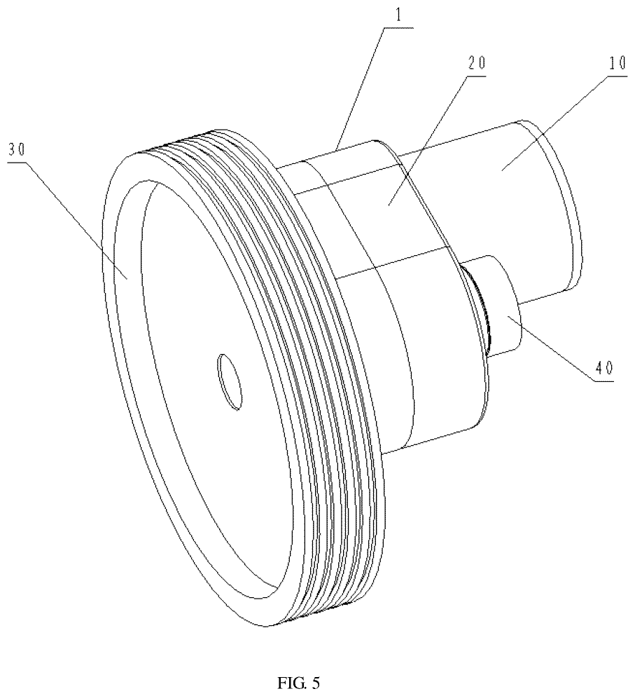

Referring to FIGS. 5-8, they show the lift drawn by a motor driver based on the motor driver of embodiment II, the motor driver 1 has a braking device 40, and the braking device 40 has a brake fixing portion 41, a brake moving portion 42, and a braking disk 43.

Preferably, the braking disk 43 and the output transmission gear 220 are coaxially connected and rotate together, and the projection of the braking disk 43 along the axial direction of the traction rope sheave 30 is configured within the area surrounded by the projection of the traction rope sheave pitch circle 310 along the axial direction of the traction rope sheave 30.

Preferably, the braking disk 43 is connected to and rotates coaxially with the output rotation shaft 22.

When the braking device operates, the brake moving portion 42 is pressed against the braking disk 43 by a spring push force, and a braking force is transmitted to the traction rope sheave 30 via the output rotation shaft 22.

### Embodiment IV

Referring to FIGS. 6, and 8, they show the lift drawn by a motor driver based on the motor driver of embodiment II, the motor driver 1 further has a sensor 50 that feeds back rotational information of the motor, the sensor 50 has a fixing portion 51 and a rotational portion 52, and the fixing portion 51 has a body portion 51a and a mounting portion 51b.

Preferably, the fixing portion 11 of the motor has a motor end cap 113, the mounting portion 51b of the fixing portion of the sensor is connected to the motor end cap 113, the body portion 51a of the fixing portion of the sensor is arranged inside an inner bore 113a of the motor end cap, and the rotary portion 52 of the sensor is connected to the input rotation shaft 21.

When the rotation portion 12 of the motor rotates, rotational information is transmitted to the sensor 50 via the input rotation shaft 21, the rotation portion 52 of the sensor, and the rotational information is fed back to the lift control system (not shown) via the sensor 50.

### Embodiment V

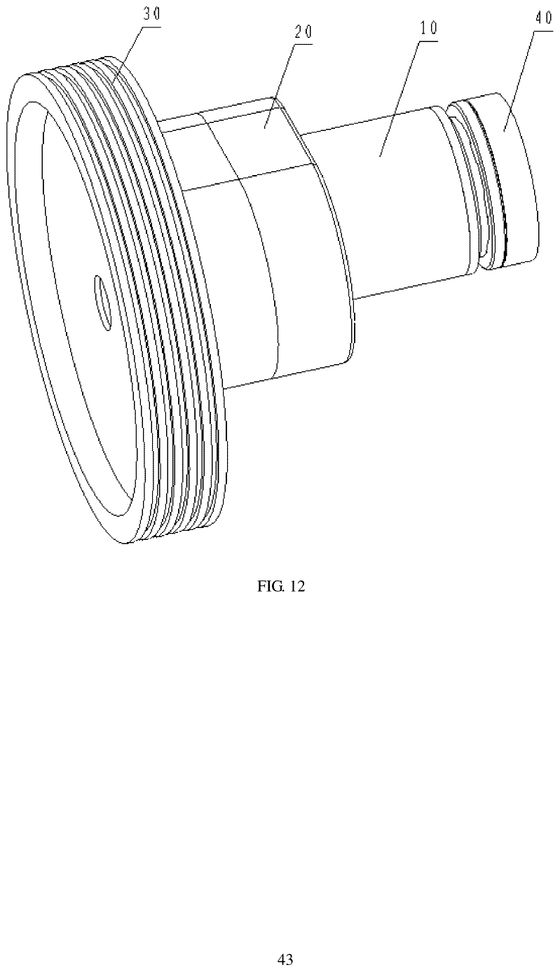

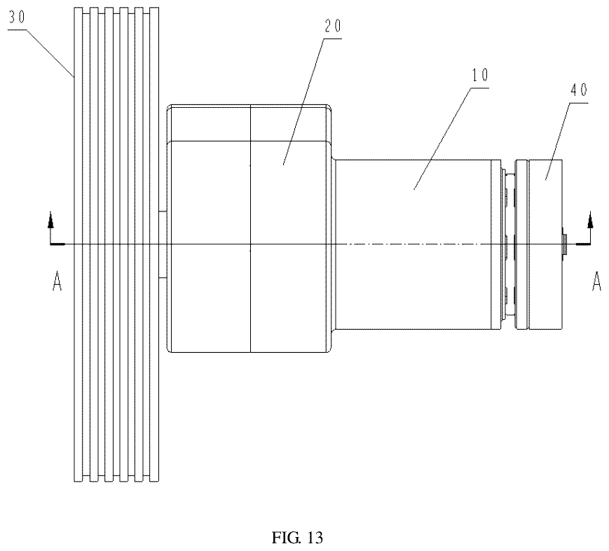

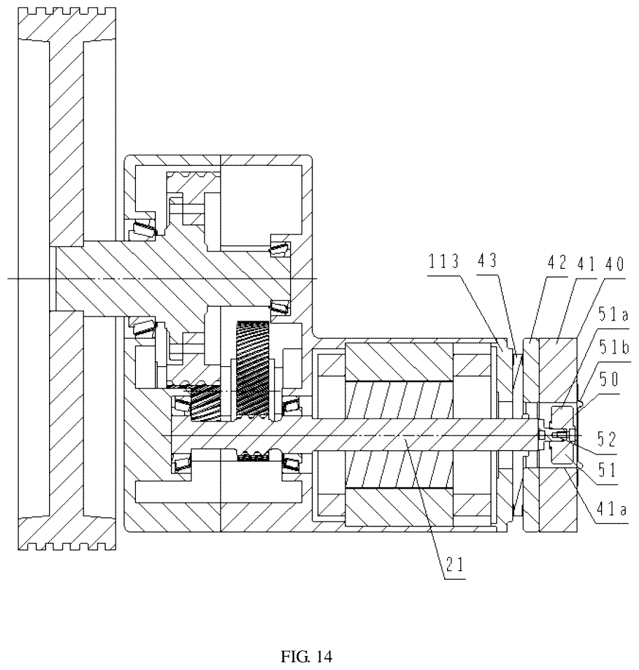

This embodiment differs from embodiments III and IV in:
referring to FIGS. 12-14, the braking disk 43 and the rotation portion 12 of the motor are coaxially connected and rotate together, and the projection of the braking disk 43 along the axial direction of the traction rope sheave 30 is configured within the area surrounded by the projection of the traction rope sheave pitch circle 310 along the axial direction of the traction rope sheave 30.

Preferably, the braking disk 43 is connected to and rotates coaxially with the input rotation shaft 21.

The fixing portion 51 of the sensor is connected to the brake fixing portion 41.

The mounting portion 51b of the fixing portion of the sensor is connected to the brake fixing portion 41, and the body portion 51a of the fixing portion of the sensor is arranged inside an inner bore 41a of the brake fixing portion.

When the braking device operates, the brake moving portion 42 is pressed against the braking disk 43 by the spring push force, and the braking force is transmitted to the traction rope sheave 30 via the input rotation shaft 21, the input transmission gear 210, the first intermediate transmission gear 230, the intermediate transmission rotation shaft 23, the second intermediate transmission gear 231, the output transmission gear 220, and the output rotation shaft 22.

The lift drawn by a motor driver in this embodiment facilitates miniaturization of the braking device to further miniaturize the motor driver by reasonably arranging the connection of the braking device with the motor and gear assembly to increase a braking torque after the output torque of the braking device is transmitted by the gear assembly.

### Embodiment VI

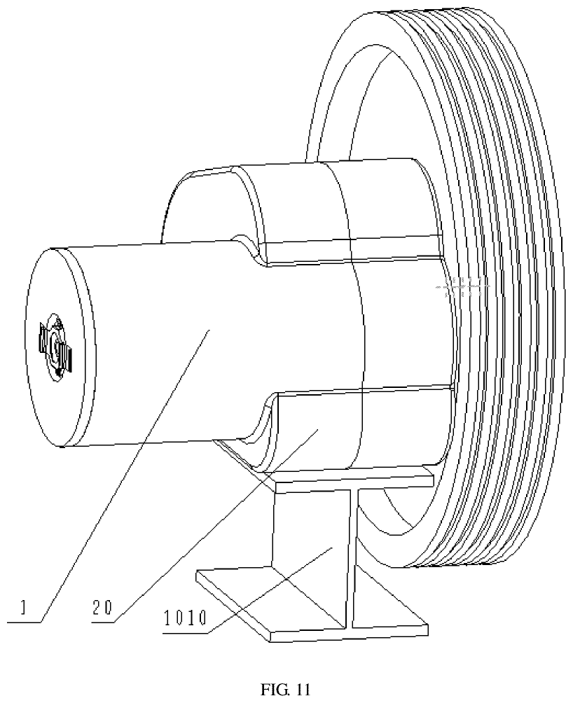

Referring to FIGS. 1, and 11, they show the lift drawn by a motor driver based on embodiment I, the lift 1000 drawn by a motor driver further has,
a first car diversion sheave 1005, and a second car diversion sheave 1006;
a counterweight diversion sheave 1007;
a car-side traction rope termination device 1008; and
a counterweight-side traction rope termination device 1009.

Preferably, a mounting bracket 1010 is also provided, which is connected to the gear box 20 of the motor driver 1 and supports the motor driver 1.

The lift drawn by a motor driver in this embodiment can reduce the space occupied at a place using a lift by providing a miniaturized mounting bracket for supporting the motor driver.

### Embodiment VII

This embodiment differs from embodiment I in:
referring to FIGS. 1-11, the axes of the individual transmission gears of the gear assembly 2 are parallel to the axis 320 of the traction rope sheave 30, and the projection of the axes of the individual transmission gears along the axial direction of the traction rope sheave 30 is configured within the area surrounded by the projection of the traction rope sheave pitch circle 310 along the axial direction of the traction rope sheave 30.

The lift drawn by a motor driver in this embodiment can further miniaturize the motor driver by a further reasonable configuration of the individual transmission gears of the gear assembly, the miniaturized designs of the transmission gears, etc.

This embodiment can be combined with any of embodiments II to VI to form a new embodiment which will not be repeated herein.

Describe above are only preferred embodiments of the present application, which are not intended to limit the present application. Any modifications, replacements, improvements, etc. made within the spirit and principle of the present application are included in the scope of protection of the application.

1-29. (canceled)

30. A lift drawn by a motor driver, comprising:
a lifting space;
a car and a counterweight lifted and lowered within the lifting space;
a traction rope suspending the car and the counterweight;
a traction rope sheave combined with the traction rope, which comprises a traction rope sheave pitch circle, wherein a rotational movement of the traction rope sheave lifts and lowers the car and the counterweight by means of the traction rope; and
the motor driver comprising a motor, and a gear assembly, the motor driving rotational movement of the traction rope sheave by the gear assembly,
wherein a projection of individual transmission gears of the gear assembly along an axial direction of the traction rope sheave is configured within an area surrounded by a projection of the traction rope sheave pitch circle along the axial direction of the traction rope sheave.

31. The lift drawn by the motor driver according to claim 30, wherein axes of the individual transmission gears of the gear assembly are stationary with respect to and parallel to the axis of the traction rope sheave.

32. The lift drawn by the motor driver according to claim 30, wherein the gear assembly has N transmission gears, axes of the N transmission gears being not in a same plane and spatially arranged in three dimensions, and N being an integer greater than 2.

33. The lift drawn by the motor driver according to claim 32, wherein the individual transmission gears of the gear assembly are between the traction rope sheave and the motor along the axial direction of the traction rope sheave.

34. The lift drawn by the motor driver according to claim 33, wherein the individual transmission gears of the gear assembly are helical gears.

35. The lift drawn by the motor driver according to claim 33, wherein
the motor driver further has a gear box, the individual transmission gears of the gear assembly being configured within the gear box, the gear box supporting rotation of the individual transmission gears of the gear assembly;
the gear assembly comprises an input transmission gear, an output transmission gear, a first intermediate transmission gear, and a second intermediate transmission gear;
the input transmission gear is provided with an input rotation shaft, and the input rotation shaft is provided with a first bearing and a second bearing;
the output transmission gear is provided with an output rotation shaft, and the output rotation shaft has a third bearing and a fourth bearing;
the first intermediate transmission gear, the second intermediate transmission gear, and an intermediate transmission rotation shaft are coaxially connected and rotate together;
the intermediate transmission rotation shaft is provided with a fifth bearing and a sixth bearing; and
the gear box rotationally supports rotation shafts by the bearings of the rotation shafts.

36. The lift drawn by the motor driver according to claim 35, wherein
the motor comprises: a fixing portion and a rotation portion; the rotation portion of the motor and the input transmission gear of the gear assembly are coaxially connected and rotate together, the traction rope sheave and the output transmission gear of the gear assembly are coaxially connected and rotate together, and a rotational speed of the traction rope sheave is less than that of the rotation portion of the motor; and
a number of teeth of the input transmission gear is less than that of a transmission gear meshed therewith, and a number of teeth of the output transmission gear is greater than that of the transmission gear meshed therewith.

37. The lift drawn by the motor driver according to claim 36, wherein
the projection of the rotation portion of the motor along the axial direction of the traction rope sheave is configured within the area surrounded by the projection of the traction rope sheave pitch circle along the axial direction of the traction rope sheave; and
the fixing portion of the motor has a coil, and the projection of the coil along the axial direction of the traction rope sheave is configured within the area surrounded by the projection of the traction rope sheave pitch circle along the axial direction of the traction rope sheave.

38. The lift drawn by the motor driver according to claim 36, wherein
the motor driver has a braking device, the braking device comprising: a brake fixing portion, a brake moving portion, and a braking disk;
the braking disk and the output transmission gear are coaxially connected and rotate together, and the projection of the braking disk along the axial direction of the traction rope sheave is configured within the area surrounded by the projection of the traction rope sheave pitch circle along the axial direction of the traction rope sheave; or,
the braking disk and the rotation portion of the motor are coaxially connected and rotate together, and the projection of the braking disk along the axial direction of the traction rope sheave is configured within the area surrounded by the projection of the traction rope sheave pitch circle along the axial direction of the traction rope sheave.

39. A lift drawn by a motor driver, comprising:
a lifting space;
a car and a counterweight lifted and lowered within the lifting space;
a traction rope suspending the car and the counterweight;
a traction rope sheave combined with the traction rope, which has a traction rope sheave pitch circle, wherein a rotational movement of the traction rope sheave lifts and lowers the car and the counterweight by means of the traction rope; and
the motor driver comprising a motor, and a gear assembly, the motor driving rotational movement of the traction rope sheave by the gear assembly
wherein axes of individual transmission gears of the gear assembly are parallel to an axis of the traction rope sheave, and a projection of the axes of the individual transmission gears along an axial direction of the traction rope sheave is configured within an area surrounded by a projection of the traction rope sheave pitch circle along the axial direction of the traction rope sheave.

40. The lift drawn by the motor driver according to claim 39, wherein the axes of the individual transmission gears of the gear assembly are stationary with respect to the axis of the traction rope sheave, the gear assembly has N transmission gears, axes of the N transmission gears being not in a same plane and spatially arranged in three dimensions, and N being an integer greater than 2.

41. The lift drawn by the motor driver according to claim 40, wherein the individual transmission gears of the gear assembly are between the traction rope sheave and the motor along the axial direction of the traction rope sheave.

42. The lift drawn by the motor driver according to claim 41, wherein the individual transmission gears of the gear assembly are helical gears.

43. The lift drawn by the motor driver according to claim 41, wherein
the motor driver further comprises a gear box, the individual transmission gears of the gear assembly being configured within the gear box, the gear box supporting rotation of the individual transmission gears of the gear assembly;
the gear assembly comprises an input transmission gear, an output transmission gear, a first intermediate transmission gear, and a second intermediate transmission gear;
the input transmission gear is provided with an input rotation shaft, and the input rotation shaft is provided with a first bearing and a second bearing;
the output transmission gear is provided with an output rotation shaft, and the output rotation shaft has a third bearing and a fourth bearing;
the first intermediate transmission gear, the second intermediate transmission gear, and an intermediate transmission rotation shaft are coaxially connected and rotate together;
the intermediate transmission rotation shaft is provided with a fifth bearing and a sixth bearing; and
the gear box rotationally supports rotation shafts by the bearings of the rotation shafts.

44. The lift drawn by the motor driver according to claim 43, wherein
the motor comprises: a fixing portion, and a rotation portion; the rotation portion of the motor and the input transmission gear of the gear assembly are coaxially connected and rotate together, the traction rope sheave and the output transmission gear of the gear assembly are coaxially connected and rotate together, and a rotational speed of the traction rope sheave is less than that of the rotation portion of the motor; and
a number of teeth of the input transmission gear is less than that of a transmission gear meshed therewith, and a number of teeth of the output transmission gear is greater than that of the transmission gear meshed therewith.

45. The lift drawn by the motor driver according to claim wherein
a projection of the rotation portion of the motor along the axial direction of the traction rope sheave is configured within the area surrounded by the projection of the traction rope sheave pitch circle along the axial direction of the traction rope sheave; and
the fixing portion of the motor has a coil, and the projection of the coil along the axial direction of the traction rope sheave is configured within the area surrounded by the projection of the traction rope sheave pitch circle along the axial direction of the traction rope sheave.

46. The lift drawn by the motor driver according to claim 44, wherein the motor driver has a braking device, the braking device comprising: a brake fixing portion, a brake moving portion, and a braking disk.

47. The lift drawn by the motor driver according to claim 46, wherein
the braking disk and the output transmission gear are coaxially connected and rotate together, and the projection of the braking disk along the axial direction of the traction rope sheave is configured within the area surrounded by the projection of the traction rope sheave pitch circle along the axial direction of the traction rope sheave; or,
the braking disk and the rotation portion of the motor are coaxially connected and rotate together, and the projection of the braking disk along the axial direction of the traction rope sheave is configured within the area surrounded by the projection of the traction rope sheave pitch circle along the axial direction of the traction rope sheave.
